(19) United States
(12) Patent Application Publication
(10) Pub. No.: US 2010/0301978 A1
(43) Pub. Date: Dec. 2, 2010

(54) LINEAR ACTUATOR

(75) Inventor: Ryo Ishibashi, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/791,089

(22) Filed: Jun. 1, 2010

(30) Foreign Application Priority Data
Jun. 1, 2009 (JP) 2009-132408

(51) Int. Cl. H01F 7/06

(52) U.S. Cl. 335/255; 310/14

(57) ABSTRACT

A linear actuator includes a coil that generates a magnetic force upon energization thereof, a yoke covering an outer peripheral surface of the coil, a magnetic attraction core that generates an attractive magnetic force in an axial direction with the magnetic force generated by the coil, a plunger that is magnetically attracted to the magnetic attraction core, and a magnetic conduct core that conducts magnetic flux received from the yoke to the plunger in a radial direction. An outer peripheral surface of the plunger is configured to slide along an inner peripheral surface of the magnetic conduct core. The plunger has a distribution-adjusting recess, which is recessed in an outer peripheral surface of a portion of the plunger made of a magnetic material to adjust magnetic flux distribution of the magnetic flux along the plunger in the axial direction with respect to the magnetic conduct core.

### CROSS REFERENCE TO RELATED APPLICATION

The present application is based on Japanese Patent Application No. 2009-132408 filed on Jun. 1, 2009, the disclosure of which is incorporated herein by reference.

### FIELD OF THE INVENTION

The present invention relates to a linear actuator configured to drive a plunger in an axial direction of the linear actuator by magnetic force generated by a coil. In the linear actuator, an outer peripheral surface of the plunger directly slides along an inner peripheral surface of a magnetic conduct core.

### BACKGROUND OF THE INVENTION

The related art will be described with reference to FIGS. 5A to 6. In the following embodiments, similar components are indicated by the same reference numerals.

As shown in FIGS. 5A and 5B, for example, JP-A-2005-299794 discloses a linear actuator 1, in which an outer peripheral surface of a plunger 4 directly slides along an inner peripheral surface of a magnetic conduct core 5. The plunger 4 and the magnetic conduct core 5 are placed with a sliding gap (a sliding clearance) interposed therebetween. The sliding gap is formed such that the plunger 4 is supported to be capable of sliding along the inner peripheral surface of the magnetic conduct core 5 in an axial direction of the linear actuator 1. The sliding gap also functions as a gap to accept a manufacturing tolerance of dimensions of an outer diameter of the plunger 4 and an inner diameter of the magnetic conduct core 5.

Since the above-described sliding gap is formed between the plunger 4 and the magnetic conduct core 5, as shown in FIG. 6, the plunger 4 deviates from an axial center of the magnetic conduct core 5 in a radial direction of the linear actuator 1 by gravity, vibration or the like. If a coil 2 is energized in this state, magnetic flux may deviate in conducting the magnetic flux from the magnetic conduct core 5 to the plunger 4 in the radial direction. If such a deviation of the magnetic flux arises, attractive force (hereinafter referred to as a radial-direction attractive force F), which is directed downward in the radial direction, is generated in the plunger 4.

The radial-direction attractive force F causes the plunger 4 and the magnetic conduct core 5 to rub against each other. The plunger 4 is locally rubbed against the magnetic conduct core 5, and thereby the plunger 4 is prevented from sliding smoothly. Thus, a sliding resistance of the plunger 4 and a hysteresis may be increased.

### SUMMARY OF THE INVENTION

The present invention is made by focusing on the following difficulty. Magnetic flux distribution in conducting magnetic flux from a magnetic conduct core to a plunger is not equalized in an axial direction of a linear actuator and the plunger is locally and strongly rubbed by magnetic flux concentration due to the unequalness of the magnetic flux distribution, and thereby the plunger is prevented from sliding smoothly due to deviation of the plunger.

It is an object of the present invention to provide a linear actuator in which a plunger can slide smoothly. In the linear actuator, magnetic flux distribution of the plunger and a magnetic conduct core in an axial direction is equalized and the plunger is prevented from being locally rubbed.

According to a first aspect of the present invention, a linear actuator includes a coil configured to generate a magnetic force upon energization thereof, a yoke covering an outer peripheral surface of the coil, a magnetic attraction core configured to generate an attractive magnetic force in an axial direction with the magnetic force generated by the coil, a plunger configured to be magnetically attracted to the magnetic attraction core, and a magnetic conduct core configured to conduct a magnetic flux, which is received from the yoke, to the plunger in a radial direction. An outer peripheral surface of the plunger is configured to slide along an inner peripheral surface of the magnetic conduct core. The plunger has a distribution-adjusting recess, which is recessed in an outer peripheral surface of a portion of the plunger made of a magnetic material to adjust a magnetic flux distribution of the magnetic flux along the plunger in the axial direction with respect to the magnetic conduct core.

By forming the distribution-adjusting recess on the outer peripheral surface of the plunger, the magnetic flux distribution of the plunger and the magnetic conduct core can be equalized in the axial direction. The magnetic flux distribution of the plunger and the magnetic conduct core is equalized in the axial direction by the distribution-adjusting recess, and thereby the plunger is prevented from being locally rubbed. Therefore, it becomes possible for the plunger to slide smoothly.

According to a second aspect of the present invention, a linear actuator includes a coil configured to generate a magnetic force upon energization thereof, a yoke covering an outer peripheral surface of the coil, a magnetic attraction core configured to generate an attractive magnetic force in an axial direction with the magnetic force generated by the coil, a plunger configured to be magnetically attracted to the magnetic attraction core, and a magnetic conduct core configured to conduct a magnetic flux, which is received from the yoke, to the plunger in a radial direction. An outer peripheral surface of the plunger is configured to slide along an inner peripheral surface of the magnetic conduct core. The magnetic conduct core has a distribution-adjusting recess, which is recessed in an inner peripheral surface of a portion of the magnetic conduct core made of a magnetic material to adjust a magnetic flux distribution of the magnetic flux along the plunger in the axial direction with respect to the plunger.

By forming the distribution-adjusting recess on the inner peripheral surface of the magnetic conduct core, the magnetic flux distribution of the plunger and the magnetic conduct core can be equalized in the axial direction. The magnetic flux distribution of the plunger and the magnetic conduct core is equalized in the axial direction by the distribution-adjusting recess, and thereby the plunger is prevented from being locally rubbed. Therefore, it becomes possible for the plunger to slide smoothly.

### BRIEF DESCRIPTION OF THE DRAWINGS

The above and other objects, features and advantages of the present invention will become more apparent from the following detailed description made with reference to the accompanying drawings. In the drawings:

FIG. 1A is a cross-sectional view showing a linear actuator according to a first embodiment;

FIG. 18 is a schematic view showing magnetic flux distribution in an axial direction;

FIG. 2A is a cross-sectional view showing a linear actuator according to a second embodiment;

FIG. 2B is a schematic view showing magnetic flux distribution in an axial direction;

FIG. 3 is a schematic view showing magnetic flux distribution in an axial direction according to a first modified example;

FIG. 4 is a schematic view showing magnetic flux distribution in an axial direction according to a second modified example;

FIG. 5A is a cross-sectional view showing a linear actuator according to a related art;

FIG. 5B is a schematic view showing magnetic flux distribution in an axial direction; and

FIG. 6 is a cross-sectional view showing a plunger and a magnetic conduct core viewed from the axial direction according to the related art.

### DETAILED DESCRIPTION OF THE PREFERRED EMBODIMENTS

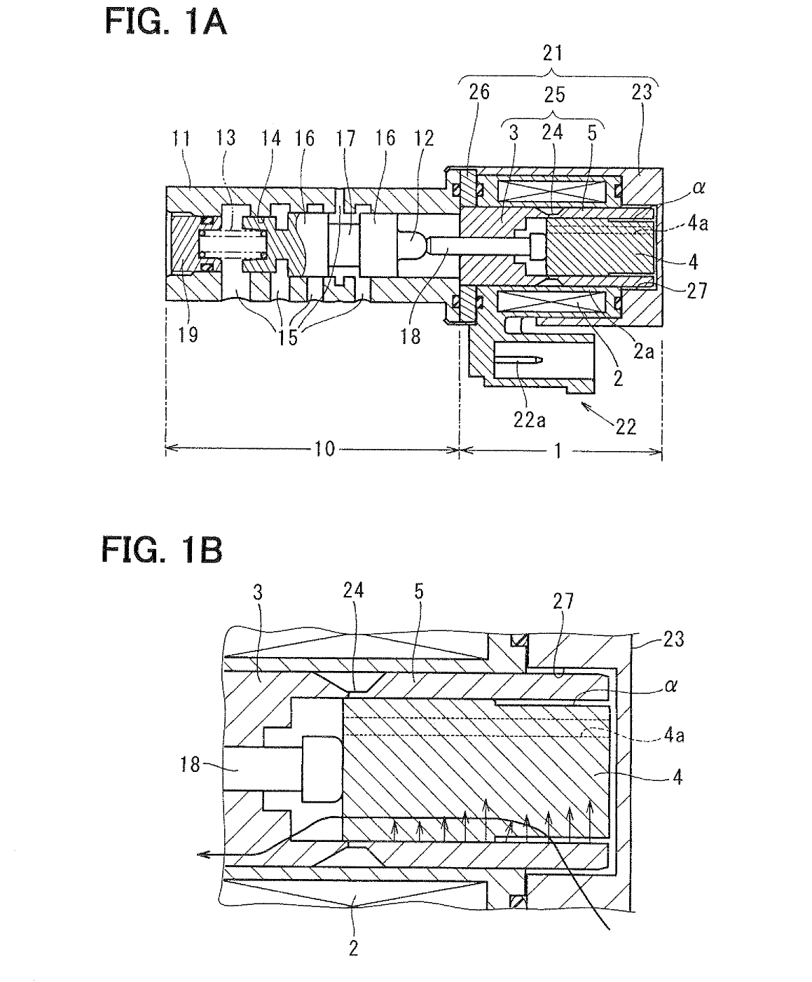

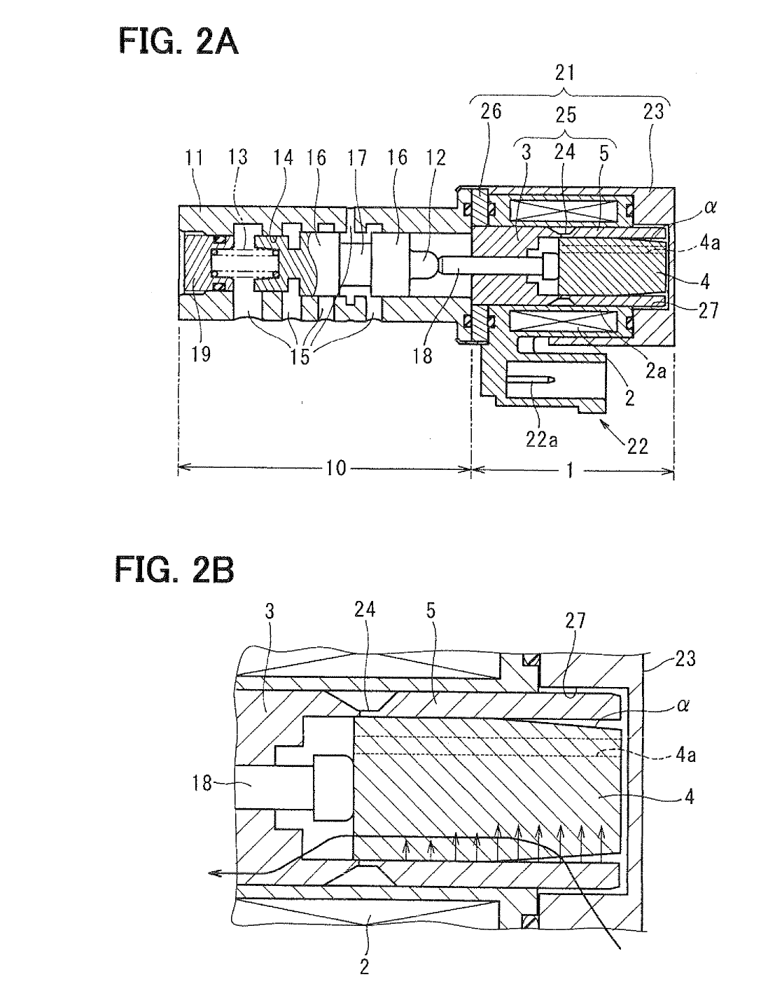

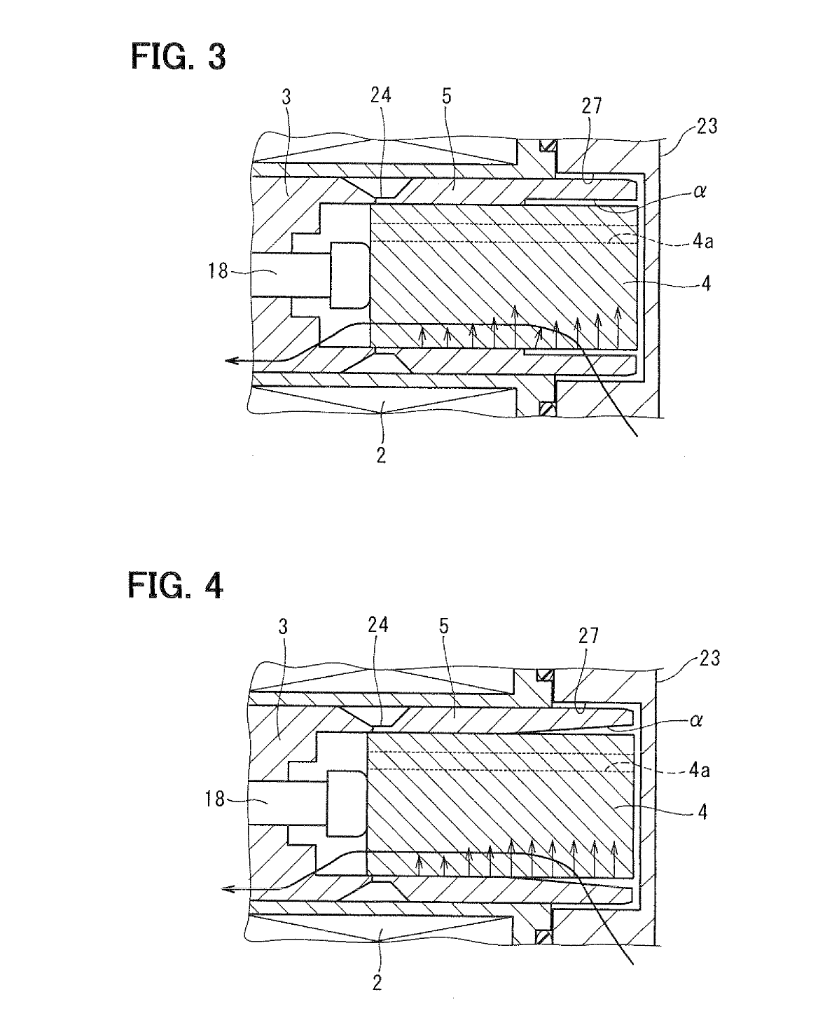

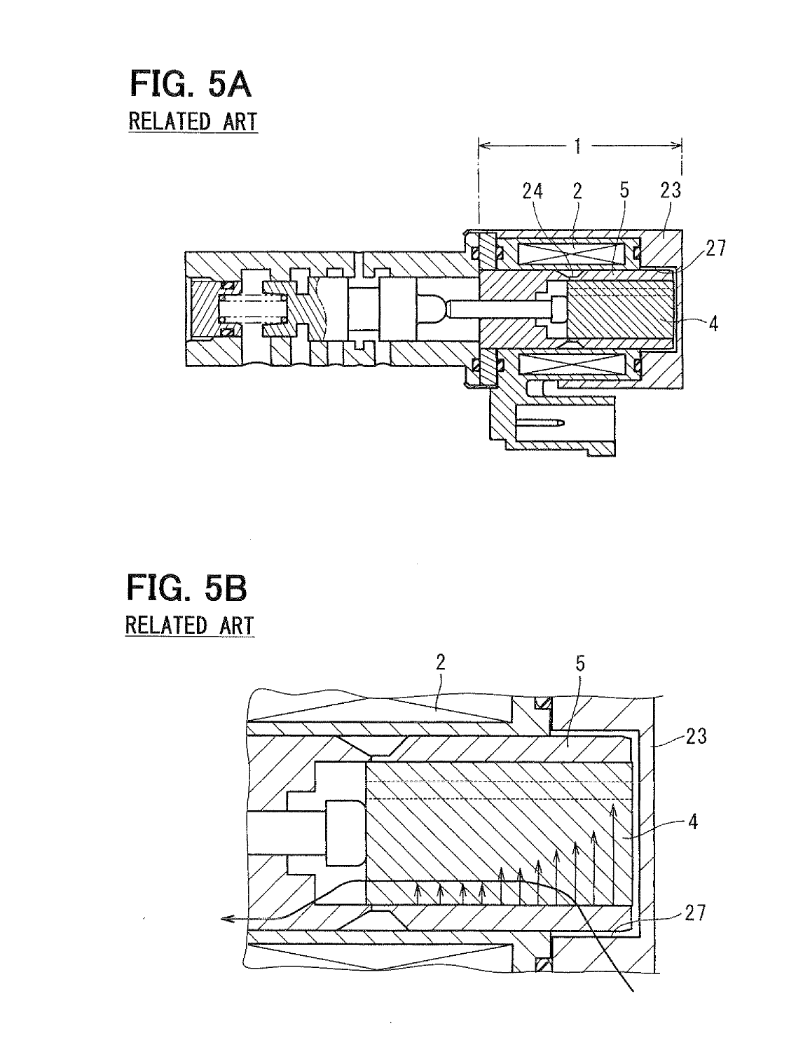

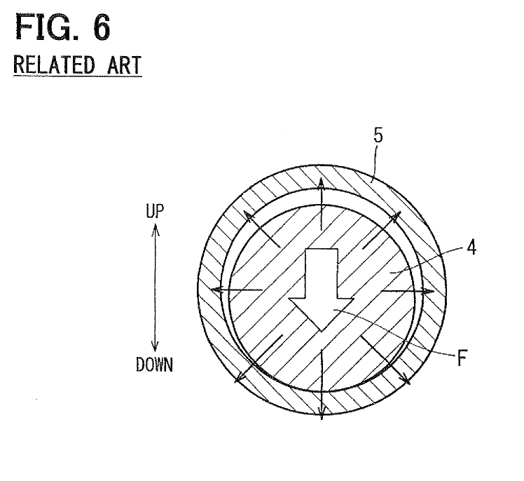

Embodiments of the present invention will be described with reference to FIGS. 1A to 4.

A linear actuator 1 includes a coil 2, a magnetic attraction core 3, a plunger 4 and a magnetic conduct core 5. The coil 2 generates magnetic force upon energization thereof. The magnetic attraction core 3 generates attractive magnetic force in an axial direction of the linear actuator 1 with the magnetic force generated by the coil 2. The plunger 4 is magnetically attracted to the magnetic attraction core 3. The magnetic conduct core 5 conducts magnetic flux to the plunger 4 in a radial direction of the linear actuator 1. An outer peripheral surface of the plunger 4 slidably contacts an inner peripheral surface of the magnetic conduct core 5.

A distribution-adjusting recess α for adjusting magnetic flux distribution in the axial direction with respect to the magnetic conduct core 5 is formed on an outer peripheral surface of magnetic material in the plunger 4, and the magnetic flux distribution of the plunger 4 and the magnetic conduct core 5 is equalized in the axial direction by the distribution-adjusting recess α.

Alternatively, the distribution-adjusting recess α for adjusting magnetic flux distribution in the axial direction with respect to the plunger 4 is formed on an inner peripheral surface of magnetic material in the magnetic conduct core 5, and the magnetic flux distribution of the plunger 4 and the magnetic conduct core 5 is equalized in the axial direction by the distribution-adjusting recess α.

### First Embodiment

A first embodiment, in which the present invention is applied to the linear actuator 1 of a hydraulic control valve in an automatic transmission, will be described with reference to FIGS. 1A and 1B. In the following embodiments, similar components are indicated by the same reference numerals. The configuration of an electro-hydraulic control valve, which will be described in the following embodiments, is one example, and the configuration is not limited thereto. For the sake of simplicity, the left side and the right side of FIG. 1A correspond to a front side and a rear side of the linear actuator 1, respectively. However, an actual mounting direction in a vehicle has no relation thereto.

The configuration of the electro-hydraulic control valve will be described with reference to FIG. 1A.

The automatic transmission for the vehicle has a hydraulic controller for transmission control. The hydraulic controller has the electro-hydraulic control valve for controlling a hydraulic pressure by an instruction of AT-ECU (i.e., electronic control unit for automatic transmission).

In particular, the electro-hydraulic control valve described in the first embodiment is attached to a housing (i.e., a case having an oil passage therein) which configures the hydraulic controller located at a lower part of the automatic transmission. The electro-hydraulic control valve is constructed of a spool valve 10 and the linear actuator 1 for driving the spool valve 10.

The spool valve 10 includes a sleeve 11, a spool 12 and a spring (e.g., a return spring) 13.

The sleeve 11 has a substantially cylindrical shape. The sleeve 11 has an insertion hole 14 in the center thereof and oil ports 15 in a radial direction thereof. The spool 12 is supported by the insertion hole 14 to be capable of sliding in an axial direction of the spool valve 10. The oil ports 15 include an input port, an output port, a discharge port, a drain port and the like. The input port communicates with an oil discharge portion of an oil pump (not shown), and an input pressure is supplied to the input port. An output pressure that is pressure-adjusted by the electro-hydraulic control valve is discharged from the output port. The discharge port communicates with a low-pressure side. The drain port is used for breathing.

The spool 12 is placed in the sleeve 11 to be capable of sliding. The spool 12 changes opening areas of the oil ports 15 and switches a communication state of the oil ports 15. The spool 12 includes multiple lands 16 that can close the oil ports 15, and a small-diameter portion 17 placed between the adjacent lands 16.

An end of the spool 12 at a side of the linear actuator 1 contacts a shaft 18 that is extended toward an inside of the linear actuator 1, and an end of the shaft 18 contacts an end surface of the plunger 4 described below so that the plunger 4 drives the spool 12 in the axial direction.

The spring 13 is a compression coil spring that biases the spool 12 toward the linear actuator 1, and is placed in a spring chamber at a front side of the sleeve 11 in a compression state. One end of the spring 13 contacts a front surface of the spool 12, and the other end of the spring 13 contacts a bottom surface of an adjusting screw 19 that closes a front end of the insertion hole 14 of the sleeve 11. The biasing force of the spring 13 can be adjusted by the amount of screwing of the adjusting screw 19.

The linear actuator 1 includes the coil 2, the plunger 4, a magnetic stator 21 and a connector 22.

The coil 2 generates magnetic force upon energization thereof and produces a magnetic flux loop passing through the plunger 4 and the magnetic stator 21. An insulating-coated conductive wire (e.g., an enamel wire) is multiple-wound around a resin bobbin 2a so that the coil 2 is formed.

The plunger 4 has a substantially columnar shape, and is made from magnetic metal (ferromagnetic material such as iron).

The plunger 4 directly slides along an inner peripheral surface of the magnetic stator 21 (specifically, an inner peripheral surface of the magnetic conduct core 5 described below).

Further, as described above, the end surface of the plunger 4 at a side of the spool 12 contacts the end of the shaft 18 of the spool 12. The plunger 4 is also biased rearward with the spool 12 by the biasing force of the spring 13, which is transmitted to the spool 12.

The plunger 4 has therein a breathing hole (or a breathing channel) 4a that penetrates the plunger 4 in the axial direction.

The magnetic stator 21 includes a yoke 23 made from magnetic material and a stator core 25 made from magnetic material. The yoke 23 has a substantially cup-like shape and covers an outer peripheral surface of the coil 2. In the stator core 25, the magnetic attraction core 3, the magnetic conduct core 5 and a magnetic shield portion (a thin portion) 24 are integrally formed.

The yoke 23 is made from magnetic metal (ferromagnetic material such as iron), through which magnetic flux flows, and covers the circumference of the coil 2. A claw portion formed at an end of the yoke 23 is caulked after the components of the linear actuator 1 are incorporated in the yoke 23 so that the yoke 23 is rigidly connected to the sleeve 11.

The magnetic attraction core 3 is magnetically coupled to a front end of the yoke 23 via a flange portion 26 made from magnetic metal (ferromagnetic material such as iron), which is fitted to an open end of the yoke 23. The magnetic attraction core 3 is made from magnetic metal (ferromagnetic material such as iron) and is opposed to the plunger 4 in the axial direction. A magnetic attraction portion (a main magnetic gap) for attracting the plunger 4 in the axial direction is formed between the magnetic attraction core 3 and the plunger 4. The magnetic attraction core 3 has therein a breathing hole (or a breathing channel) that penetrates the magnetic attraction core 3 in the axial direction. The breathing hole is not shown in the drawing. In the present embodiment, the example in which the magnetic attraction core 3 is fixed to an inner peripheral surface of the flange portion 26 by a fixation technology such as press fitting is shown. However, the flange portion 26 and the magnetic attraction core 3 may be integrally formed.

A cylindrical recess is formed at a rear end of the magnetic attraction core 3, into which a front end of the plunger 4 can be inserted. The cylindrical recess is formed such that a part of the plunger 4 is capable of intersecting with the axial direction inside the cylindrical recess. A tapered portion, whose diameter is decreased rearward, is formed around an outer peripheral surface of the cylindrical recess. The tapered portion is formed such that magnetic attraction force is not changed with respect to the amount of stroke of the plunger 4.

The magnetic conduct core 5 is made from magnetic metal (ferromagnetic material such as iron) and has a cylindrical shape covering a substantially entire surface of the plunger 4. A rear end of the magnetic conduct core 5 is placed in a magnetic coupling hole 27 formed on a bottom portion (i.e., a rear side) of a cup of the yoke 23 so that the magnetic conduct core 5 is magnetically coupled to the yoke 23.

The plunger 4 directly slides along the inner peripheral surface of the magnetic conduct core 5. The magnetic conduct core 5 conducts the magnetic flux to the plunger 4 in the radial direction. A magnetic conduct portion (a side magnetic gap) is formed between the magnetic conduct core 5 and the plunger 4.

The magnetic shield portion 24 is a magnetic saturation portion that prevents the magnetic flux from flowing directly between the magnetic attraction core 3 and the magnetic conduct core 5, and is formed from the thin portion having large magnetic resistance. Multiple holes that penetrate the thin portion in the radial direction are formed all over the thin portion so as to decrease the magnetic flux passing through the thin portion.

The connector 22 is a connecting portion, which is electrically connected to the AT-ECU that controls the electro-hydraulic control valve via a connecting wire. The connector 22 has therein terminals 22a connected to the both ends of the coil 2, respectively.

As described in the present embodiment, in the linear actuator 1 in which the plunger 4 directly slides along the inner peripheral surface of the magnetic conduct core 5, a sliding gap is formed between the plunger 4 and the magnetic conduct core 5 in the radial direction. Thus, in the case where the plunger 4 is made from magnetic metal only, as shown in FIG. 6, the plunger 4 deviates from the axial center of the magnetic conduct core 5 in the radial direction by gravity, vibration or the like. If the plunger 4 is magnetically attracted to the magnetic attraction core 3 by energizing the coil 2 when the plunger 4 deviates, deviation of the magnetic flux arises in conducting the magnetic flux from the magnetic conduct core 5 to the plunger 4 in the radial direction. If such a deviation of the magnetic flux arises, the radial-direction attractive force F is generated in the plunger 4, and thereby the plunger 4 is prevented from sliding smoothly.

In particular, in the conventional linear actuator 1, by lengthening a dimension of the magnetic conduct core 5 in the axial direction and a contact length of the plunger 4 and the magnetic conduct core 5, a region in which the magnetic flux is conducted from the magnetic conduct core 5 to the plunger 4 is expanded, and thereby the local deviation of the magnetic flux is suppressed. For example, as shown in FIGS. 5A and 5B, by extending the dimension of the magnetic conduct core 5 in the axial direction from the bottom portion of the yoke 23 to the magnetic shield portion 24, the region in which the magnetic flux is conducted from the magnetic conduct core 5 to the plunger 4 is expanded.

However, even if the dimension of the magnetic conduct core 5 in the axial direction is extended, as shown in FIG. 5B, magnetic flux concentration arises in a rear end of the plunger 4 (a portion near the magnetic coupling hole 27 of the yoke 23), and the plunger 4 is prevented from sliding smoothly.

In order to avoid the above-described difficulty, in the first embodiment, a distribution-adjusting recess α is formed on the outer peripheral surface of magnetic material in the plunger 4 so that magnetic flux distribution of the plunger 4 and the magnetic conduct core 5 is equalized in the axial direction.

In particular, the plunger 4 of the first embodiment is configured such that a nonmagnetic material layer is formed on a surface of the magnetic metal having the substantially columnar shape, for example. The distribution-adjusting recess α of the present embodiment is formed on the outer peripheral surface of the rear end of the plunger 4 (the portion near the magnetic coupling hole 27 of the yoke 23) so as to suppress the magnetic flux concentration of the rear end of the plunger 4 (the portion near the magnetic coupling hole 27 of the yoke 23).

The distribution-adjusting recess α is formed on the outer peripheral surface of the magnetic metal at the rear end of the plunger 4 by cutting work.

A cylinder portion having a diameter smaller than the outer diameter of the plunger 4 (a sliding diameter with respect to the magnetic conduct core 5) is formed in a part of the plunger 4 so that the distribution-adjusting recess α is formed on the plunger 4. In the first embodiment, the distribution-adjusting recess α is defined by a surface of the cylinder portion having a constant diameter (a surface of the small-diameter cylinder portion). In other words, a trench is formed around the outer peripheral surface of a part of the plunger 4 so that the distribution-adjusting recess α is formed on the plunger 4.

A dimension of the distribution-adjusting recess α in the axial direction is set to be larger than that of the magnetic coupling hole 27 of the yoke 23 in the axial direction.

A depth (a dimension in the radial direction) of the distribution-adjusting recess α is set such that magnetic flux density in the radial direction at a front portion (including a middle portion) of the plunger 4, at which the distribution-adjusting recess α is not formed, becomes approximately equal to that at a rear portion of the plunger 4, at which the distribution-adjusting recess α is formed.

In this manner, by forming the distribution-adjusting recess α on the outer peripheral surface of the plunger 4, the magnetic flux concentration generated at the rear end of the plunger 4 (the portion near the magnetic coupling hole 27 of the yoke 23) can be avoided. As shown in the arrows of FIG. 1B, the magnetic flux distribution of the plunger 4 and the magnetic conduct core 5 can be equalized in the axial direction.

Thus, the rear end of the plunger 4 can be prevented from being locally rubbed against the magnetic conduct core 5, and the plunger 4 can slide smoothly. Therefore, a sliding resistance of the plunger 4 can be decreased, and further, occurrence of a hysteresis can be suppressed. That is, by forming the distribution-adjusting recess α on the outer peripheral surface of the plunger 4, performance of the electro-hydraulic control valve included in the automatic transmission can be increased.

### Second Embodiment

A second embodiment will be described with reference to FIGS. 2A and 2B.

In the present embodiment, similar components to those in the first embodiment are indicated by the same reference numerals.

In the first embodiment, the distribution-adjusting recess α is formed by the surface of the cylinder portion having the constant diameter.

In contrast, in the second embodiment, the distribution-adjusting recess α is formed by a tapered surface having a conical shape.

In particular, in the case where the distribution-adjusting recess α is not formed, the magnetic flux concentration in the radial direction is increased toward the rear end of the plunger 4, as shown in FIG. 5B.

In the second embodiment, the distribution-adjusting recess α is formed by the tapered surface such that a gap between the plunger 4 and the magnetic conduct core 5 in the radial direction becomes larger toward the rear end of the plunger 4, that is, a diameter of the outer peripheral surface of the plunger 4 is decreased toward the rear end thereof.

In this manner, by forming the distribution-adjusting recess α, as shown in FIG. 2B, the magnetic flux distribution of the plunger 4 and the magnetic conduct core 5 can be further equalized in the axial direction, and deterioration in sliding performance of the plunger 4 due to uneven magnetic flux can be suppressed.

In the above-described embodiments, the distribution-adjusting recess α is formed to be exposed on the outer peripheral surface of the plunger 4. In contrast, after the distribution-adjusting recess α is formed on the magnetic metal in the plunger 4, the distribution-adjusting recess α may be filled up with nonmagnetic material (nonmagnetic metal, resin or the like). Therefore, a pressure of a contact surface between the plunger 4 and the magnetic conduct core 5 can be reduced, and the sliding performance of the plunger 4 can be further improved.

In the above-described embodiments, the distribution-adjusting recess α is formed on the outer peripheral surface of the plunger 4. In contrast, as shown in FIGS. 3 and 4, the distribution-adjusting recess α may be formed on the inner peripheral surface of the magnetic conduct core 5. In this case, the distribution-adjusting recess α is defined by a surface of a cylinder having a diameter larger than a minimum diameter of the magnetic conduct core 5 or a trench formed around the inner peripheral surface of the magnetic conduct core 5. In this manner, when the distribution-adjusting recess α is formed on the inner peripheral surface of the magnetic conduct core 5, the similar effect to the first and second embodiments can be obtained.

As with the above-described embodiments, the distribution-adjusting recess a formed on the inner peripheral surface of the magnetic conduct core 5 may be filled up with nonmagnetic material (nonmagnetic metal, resin or the like).

In the above-described embodiments, the magnetic conduct core 5 is formed integrally with the magnetic attraction core 3 via the magnetic shield portion 24. In contrast, the magnetic conduct core 5 may be formed by material different from material for the magnetic attraction core 3.

In the above-described embodiments, the plunger 4 is driven toward an opening side (front side) of the yoke 23. In contrast, the present invention may be applied to the linear actuator 1 in which the plunger 4 is driven toward a bottom side (rear side) of the yoke 23. That is, the present invention may be applied to the linear actuator 1 in which the magnetic attraction core 3 is placed at the bottom side (rear side) of the yoke 23 and the magnetic conduct core 5 is placed at the opening side (front side) of the yoke 23.

In the above-described embodiments, the plunger 4 directly slides along the inner peripheral surface of the magnetic conduct core 5. In contrast, the following configuration may be used. A nonmagnetic thin cup is inserted and received inside the inner peripheral surface of the magnetic conduct core 5, and the plunger 4 is supported to be capable of sliding along an inner peripheral surface of the cup.

In the above-described embodiments, the present invention is applied to the electro-hydraulic control valve used for a hydraulic control device of the automatic transmission. However, the present invention may be applied to another electro-hydraulic control valve other than the automatic transmission. Further, the present invention may be applied to a solenoid valve other than the electro-hydraulic control valve.

In the above-described embodiments, the present invention is applied to the linear actuator 1 that drives a valve (the spool valve 10 in the embodiments). However, the present invention may be applied to the linear actuator 1 that drives directly or indirectly a body to be driven other than the valve.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A linear actuator comprising:
a coil configured to generate a magnetic force upon energization thereof;
a yoke covering an outer peripheral surface of the coil;
a magnetic attraction core configured to generate an attractive magnetic force in an axial direction with the magnetic force generated by the coil;
a plunger configured to be magnetically attracted to the magnetic attraction core; and
a magnetic conduct core configured to conduct a magnetic flux, which is received from the yoke, to the plunger in a radial direction, wherein
an outer peripheral surface of the plunger is configured to slide along an inner peripheral surface of the magnetic conduct core, and
the plunger has a distribution-adjusting recess, which is recessed in an outer peripheral surface of a portion of the plunger made of a magnetic material to adjust a magnetic flux distribution of the magnetic flux along the plunger in the axial direction with respect to the magnetic conduct core.

2. The linear actuator according to claim 1, wherein
the yoke has a magnetic coupling hole in which the magnetic conduct core is placed,
the magnetic flux is conducted from the magnetic conduct core to the plunger in the magnetic coupling hole, and
the distribution-adjusting recess is formed near the magnetic coupling hole.

3. The linear actuator according to claim 1, wherein
the distribution-adjusting recess is defined by a surface of a cylinder portion having a constant diameter.

4. The linear actuator according to claim 1, wherein
the distribution-adjusting recess is defined by a tapered surface having a conical shape.

5. The linear actuator according to claim 2, wherein
a dimension of the distribution-adjusting recess in the axial direction is larger than a dimension of the magnetic coupling hole in the axial direction.

6. A linear actuator comprising:
a coil configured to generate a magnetic force upon energization thereof;
a yoke covering an outer peripheral surface of the coil;
a magnetic attraction core configured to generate an attractive magnetic force in an axial direction with the magnetic force generated by the coil;
a plunger configured to be magnetically attracted to the magnetic attraction core; and
a magnetic conduct core configured to conduct a magnetic flux, which is received from the yoke, to the plunger in a radial direction, wherein
an outer peripheral surface of the plunger is configured to slide along an inner peripheral surface of the magnetic conduct core, and
the magnetic conduct core has a distribution-adjusting recess, which is recessed in an inner peripheral surface of a portion of the magnetic conduct core made of a magnetic material to adjust a magnetic flux distribution of the magnetic flux along the plunger in the axial direction with respect to the plunger.

7. The linear actuator according to claim 6, wherein
the yoke has a magnetic coupling hole in which the magnetic conduct core is placed,
the magnetic flux is conducted from the magnetic conduct core to the plunger in the magnetic coupling hole, and
the distribution-adjusting recess is formed near the magnetic coupling hole.

8. The linear actuator according to claim 6, wherein
the distribution-adjusting recess is defined by a surface of a cylinder portion having a constant diameter.

9. The linear actuator according to claim 6, wherein
the distribution-adjusting recess is defined by a tapered surface having a conical shape.

10. The linear actuator according to claim 7, wherein
a dimension of the distribution-adjusting recess in the axial direction is larger than a dimension of the magnetic coupling hole in the axial direction.
